(19) United States
(12) Patent Application Publication
(10) Pub. No.: US 2003/0123493 A1
(43) Pub. Date: Jul. 3, 2003

(54) Network, switching apparatus and OTN frame processing method for use therein; its circuit and integrated circuit

(75) Inventor: Seigo Takahashi, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/321,659

(22) Filed: Dec. 18, 2002

(30) Foreign Application Priority Data
Dec. 19, 2001 (JP) 385430/2001

(51) Int. Cl. H04J 3/02

(52) U.S. Cl. 370/539; 370/541

(57) ABSTRACT

An OTN cross-connecting apparatus (100) constituting a second network is arranged on a boundary to a first network. The OTN framer (220) of a client interface card (200) mounted on the OTN cross-connecting apparatus (100) stores an SDH/SONET signal into an OTN frame on a non-interfering manner and, using the overhead of the second network OTN frame, controls and manages the apparatus and the network.

### BACKGROUND OF THE INVENTION

1. Field of the Invention

The present invention relates to a network, a switching apparatus and an OTN frame processing method for use therein together with its circuit and integrated circuit, and more particularly to an apparatus capable of providing clear channels to a client network in a cross-connecting apparatus for performing connection within a communication network and a network using this apparatus.

2. Description of the Related Art

In a network consisting of a cross-connecting apparatus (hereinafter referred to as XC apparatus) and an add-drop multiplexer (hereinafter referred to as ADM) apparatus, if a client network built up of a frame based on a synchronous optical network/synchronous digital hierarchy (SONET/SDH) (hereinafter referred to as SDH), such as shown in FIG. 1, partly borrows lines from a carrier network which is similarly built up of an SDH-based frame but whose management system, which may be typically a network management system (NMS), differs from that of the first network, contention for SDH overhead (hereinafter referred to as OH) information will arise between these two networks.

Then, contradictions will occur among various sets of OH information. For instance, 1) as control information items regarding the transfer of alarms, such as K1 and K2, set on the part of a client network 1 are altered, protection is not normally operated as viewed from the client network 1; 2) as error information items such as B1 and B2 are altered, error occurrence is detected even though the actual information is free of errors; or 3) data communication channels D1 through D3 are cut off to make it impossible to transfer control information between apparatuses.

For instance, it is supposed that, where a network is to be built up in the client network 1 by using an SDH apparatus of synchronous transport module level 16 (STM-16) as shown in FIG. 2, some of the transmission paths in the network are borrowed from a carrier network 2 of another communication company as STM-16. In each of the client SDH network 1 and the carrier SDH network 2, network control is carried out using the OH information of SDH.

The management system of the client SDH network 1 logically is interpreted as being connected by a connecting route 11 as shown in FIG. 3. However, in reality, the connection is accomplished from a transmission path 11a, via a carrier edge node 31 and the borrowed transmission path 21 of the carrier network 2, and passes the transmission path 11b of the client network 1.

At the J0 byte, for instance, the value of J01 is entered on the first route 11a. The management system of the client network 1 interprets that the same J01 holds over the whole span of the route 11. In reality, however, at the carrier edge node 31 before entering the transmission path 21, the carrier network 2 overwrites the value of J02 into the J0 byte as new information. As a result, by the time of return to the route 11b, the memory of J01 is lost, and J02 or J03, which is entirely different, is entered instead, resulting in contradiction with the value of J01 expected by the management system of the client network 1.

The carrier network 2 is required to provide a service which would permit transmission of OH information on the client network 1 side as a service which would make possible avoidance of such contention for OH information (clear channel service).

To meet such a requirement, according to the prior art, it is proposed to save the needed OH information of the client network 1 in an unoccupied OH area for the OH information of SDH while the inside of the carrier network is being passed.

This method is described in “Overhead transparency improves interoperability of optical networks” [Andrew Schmitt (Vitesse Semiconductor Corp.), LIGHTWAVE journal, Vol. 17, Issue 9, pp. 104-10, August 2000]. This article is also disclosed in a home page, the URL of which is as follows:

http://lw.pennnet.com/Articles/Article Display.cfm?Section=A rchives&Subsection=Display&ARTICLE ID=77934

By using this system, it is made possible to realize a partial clear channel service.

For instance, as shown in FIG. 4, at the time the carrier network 2 receives an STM-16 signal from the client network 1, the OH information byte value J0 of an STM-16 signal on the client network 1 side is written into an unoccupied byte of OH (saved, 6a in FIG. 4) and transferred within the carrier network 2.

At the time the STM-16 signal is delivered again as such from the carrier network 2 to the client network 1, OH byte information J01b which has been saved is written back into the initial byte position before it was saved (OH byte information J01c) (6b in FIG. 4). By going through such a procedure, it is made possible to normally operate the network control and management of the client network 1.

Since an ADM apparatus can be interpreted as a simplified form of an XC apparatus, reference to the XC apparatus in the following description will also cover the ADM.

However, the conventional network described above uses a procedure by which a specific set of OH information is saved into a specific unoccupied OH area. This involves a problem that if lines are borrowed in a recursive way (in a nested pattern) that procedure will prove incompatible.

For instance, if there arises a situation in which a carrier 2a again borrows lines from another carrier 2b as shown in FIG. 5, OH information will have to be recursively saved. If in this case the carrier 2b processes similar OH saving again, OH information of the client network 1 will be lost as a result of overwrite.

In this case, there is another problem that, if the OH information is saved into another unoccupied OH area anew, it may be difficult to know whether or not a supposedly unoccupied area is already used for saving OH and, because the destination of saving varies with the number of times of recursion, it becomes necessary to manage the destinations of saving (the frequency of saving). SDH has no signaling mechanism to solve these two problems.

On the other hand, where the integrated circuit (IC) to process OH saving is to be configured to be capable of recursive saving, processing of high speed signals such as STM-16 or STM-64 would complicate the IC design. This might make the realization difficult or too costly.

The network according to the prior art involves another problem that the OH information to be saved is fixed. As the OH information to be saved on the carrier side is fixed, it is impossible on the client side to exchange signaling information by using a random unoccupied OH byte. Even if, for instance, a Packet over SONET (PoS) interface card of the router uses unoccupied OH in a non-standard way for the purpose of managing a transmission path between routers and performs signaling in its own way, that signaling information cannot penetrate the carrier network.

Moreover, there is a problem that in a network according to the prior art the destination of the saving of OH information is fixed. In saving OH information, since the unoccupied OH byte into which the information is to be written is fixed, the use of unoccupied OH bytes on the carrier side is restricted. For instance, one carrier or a second carrier may use an unoccupied OH byte and performs signaling it its own way for the purpose of network management. The supposedly unoccupied OH byte may be already used, but there is no guarantee that all information on the byte to be used can be known. In other words, the return of saved OH information is not warranted.

For the reasons stated above, by using an SDH frame as it is, it is impossible to provide complete clear channel service or extremely complex signaling would be required to manage the OH saving status.

### SUMMARY OF THE INVENTION

An object of the present invention is to obviate the problems noted above, and to provide a network, a switching apparatus and an OTN frame process method for use therein, together with its circuit and integrated circuit, capable of providing client signals with a clear channel service via networks differing in management system such as between a plurality of carriers.

According to the invention, there is provided a network in which some of the lines of a client network for transmitting client signals comprise a carrier network for transmitting an optical transport network (OTN) frame, including in the carrier network a switching apparatus having a mapping unit for mapping the client signals on the payload portion of the OTN frame and a switching unit for switching the frame on which the client signals are mapped by the mapping unit on the optical channel data unit-k (ODUk) sublayer of an OTN layer.

A switching apparatus according to the invention has a mapping unit for mapping the client signals on the payload portion of the OTN frame and a switching unit for switching the frame on which the client signals are mapped on the ODUk sublayer of an OTN layer.

According to the invention, there is also provided an OTN frame processing method for use in a network in which some of the lines of a client network for transmitting client signals comprise a carrier network for transmitting an OTN frame, whereby the client signals are mapped on the payload portion of the OTN frame and the frame on which the client signals are mapped is switched on the ODUk sublayer of an OTN layer.

An OTN frame processing circuit according to the invention processes an OTN frame in a switching apparatus, wherein byte information in either a random position or a specific position is at least either read or written out of or into an unused FEC area of the OTN frame.

An integrated circuit according to the invention constitutes an OTN frame processing circuit which processes an OTN frame in a switching apparatus, wherein byte information in either a random position or a specific position is at least either read or written out of or into an unused FEC area of the OTN frame.

### BRIEF DESCRIPTION OF THE DRAWINGS

The above and other objects, features and advantages of the present invention will become more apparent from the following detailed description when taken in conjunction with the accompanying drawings wherein:

FIG. 1 illustrates the operation of an edge XC apparatus shown in FIG. 13;

FIG. 2 illustrates an application according to the prior art;

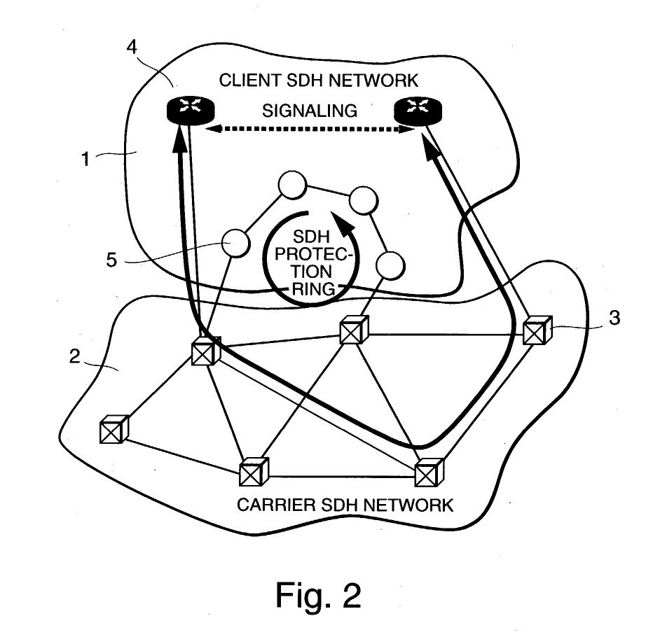

FIG. 3 illustrates processing by a network management system according to the prior art;

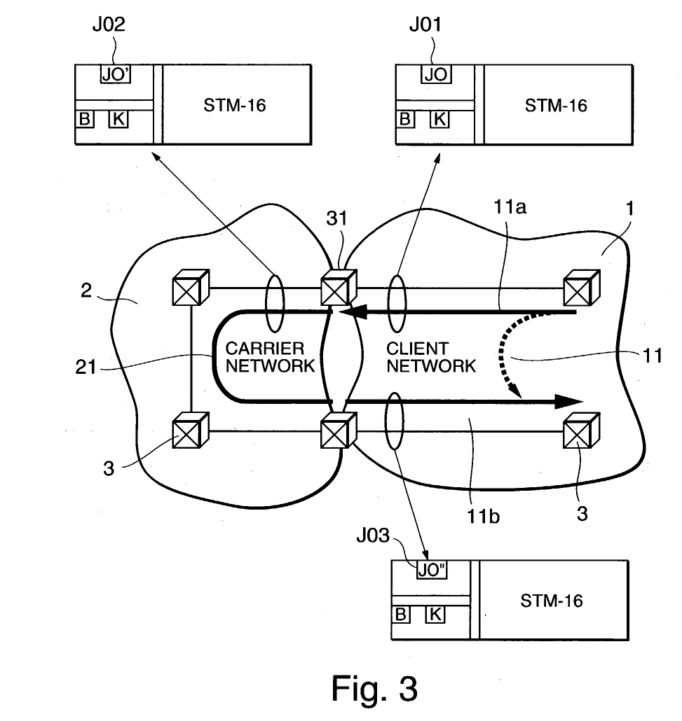

FIG. 4 illustrates processing by another network management system according to the prior art;

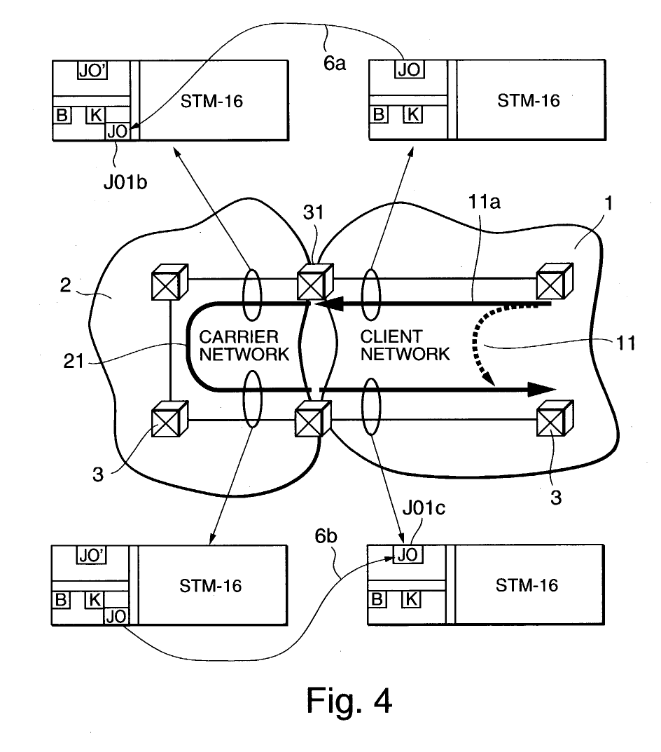

FIG. 5 illustrates another application according to the prior art;

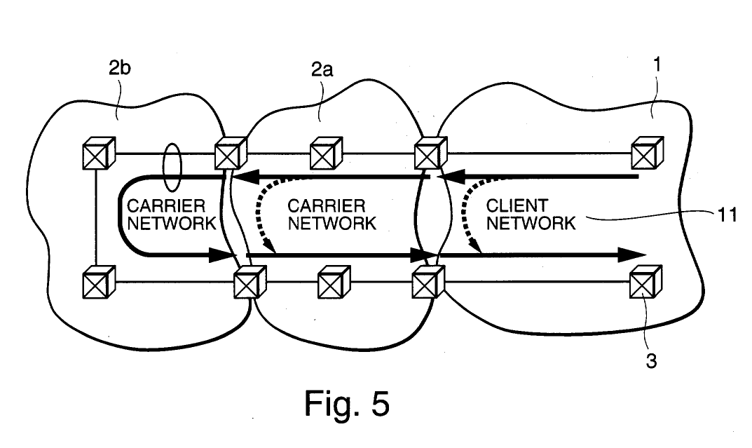

FIG. 6 is a block diagram of the configuration of an OTN XC apparatus, which is a first preferred embodiment of the invention;

FIG. 7 illustrates processing by an OTN layer in the OTN XC apparatus, which is the first embodiment of the invention;

FIGS. 8(a) and (b) illustrates layer processing using TCM by the first embodiment;

FIG. 9 illustrates apparatus control in the first embodiment;

FIG. 10 illustrates apparatus control in the first embodiment in another way;

FIG. 11 illustrates apparatus control in the first embodiment in still another way;

FIG. 12 illustrates apparatus control in the first embodiment in yet another way;

FIG. 13 is a block diagram of the configuration of an OTN XC apparatus, which is a second preferred embodiment of the invention;

FIG. 14 illustrates the operation of an edge XC apparatus shown in FIG. 13;

FIG. 15 illustrates processing by a client-OTN adaptation layer in the OTN XC apparatus, which is the second embodiment of the invention;

FIGS. 16(a) to (c) illustrates processing by a network management system according to the invention;

FIGS. 17(a) and (b) illustrates processing by a network management system according to the invention in another way;

FIGS. 18(a) to (c)) illustrates processing by a network management system according to the invention in still another way;

FIGS. 19(a) and (b) illustrates processing by a network management system according to the invention in yet another way; and

FIG. 20 is a block diagram of the configuration of an OTN XC apparatus, which is another embodiment of the invention.

### DETAILED DESCRIPTION OF THE PREFERRED EMBODIMENTS

(First Preferred Embodiment)

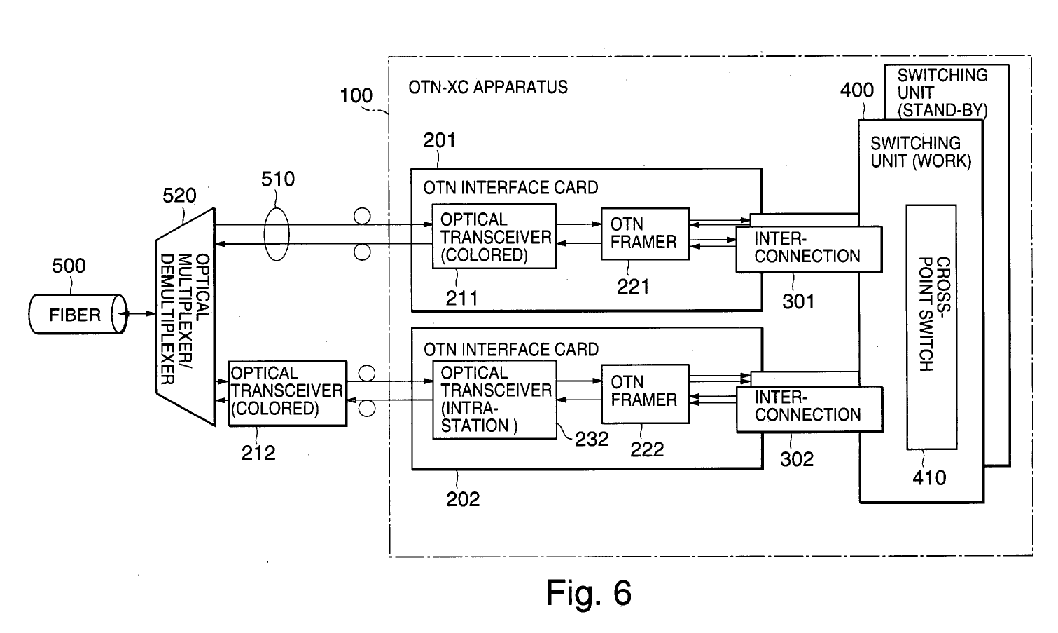

Preferred embodiments of the present invention will be described in detail below with reference to accompanying drawings. FIG. 6 is a block diagram of the configuration of an OTN XC apparatus, which is a first preferred embodiment of the invention. Referring to FIG. 6, an OTN XC apparatus 100, which is the first embodiment of the invention, is intended for arrangement within an OTN network, and comprises OTN interface cards (OTN I/F cards) 201 and 202 and a switching unit (SWU) 400.

OTN-XC nodes are connected to each other by an optical fiber 500 via an optical multiplexer/demultiplexer 520. The bit rate of a signal corresponding to a connection 510, which corresponds to one wavelength, is OUT-n (n=1, 2 or 3) as prescribed by G.709 of ITU-T.

The OTN I/F card 201 comprises an optical (colored) transceiver 211 connected to a transmission path, an OTN frame processing circuit (framer) [OTN termination (TRM)] 221 and an intra-apparatus interface (inter-connection 301 connected to the switching unit 400. The OTN interface card 202 comprises an (intra-station) optical transceiver 232, an OTN framer 222 and an intra-apparatus interface 302 connected to the switching unit 400, and an optical (colored) transceiver 212 is arranged on the transmission path side.

The optical transceivers 211 and 213 performs photo electric conversion of optical signals received from the fiber of the transmission path and electrooptic conversion of signals to be transmitted to the fiber of the transmission path. The inter-connections 301 and 302 connect the OTN interface cards 201 and 202 to the switching unit 400 by using electrical signals or optical signals.

The switching unit 400 is connected to the plurality of OTN I/F cards 201 and 202 via the inter-connections 301 and 302, and provides connections between I/F cards in one-to-one or one-to-multiple combinations.

To this switching unit can be applied a cross-point switching (XPSW) device 410 using an electrical circuit or one of various optical switches. A conceivable XPSW consisting of an electrical circuit here may be an analog switch configured in an IC. It is also possible to apply an analog switch IC using a phase lock loop (PLL) on either one or both of the input/output ports of the switch and having a clock regenerating function. An optical switch-based XPSW may comprise an optical switch configured of a waveguide circuit fabricated over one of various substrates made up of quartz, lithium niobite (LN) or some organic material, or a micro-electronic mechanical system (MEMS) optical switch.

Since the bit rate of signals may have errors in a certain extent in the OTN network, the switch unit 400 used within the OTN-XC apparatus, as used in an SDH network according to the prior art, requires no strict clock synchronism, and is characterized by its relatively flexible, analog switch-like operation against variations in the clock frequency of signals, transmitting and switching signals without being conscious of the phase of the OTN frame.

The bit rate of signals penetrating the switching unit 400 is the same as that of signals on the transmission path or the quotient of the same divided by an integer. By way of example, a case in which the XPSW electrical circuit constituting the switching unit 400 operates in a band whose upper limit is 3 Gbps will be described. Where signals of an optical channel transport unit-1 (OTU-1) are to be cross-connected, signals of 2,666 Gbps on the transmission path will pass the switching unit 400 without changing the bit rate, and be transferred to the I/F card on the output side.

Where signals of an OTU-2 are to be cross-connected, as the bit rate on the transmission path is 10,709 Gbps, they are converted into parallel signals by the input side interface using a quadrisecting deserializer, and the signals are passed by the switching unit 400 at a bit rate of 2,677 Gbps. The output side interface card regenerates, using a serializer, signals of 10,709 Gbps again from the four-channel parallel signals.

Where an optical switch is used in the switching unit 400, it is also possible to pass signals having the same bit rate as signals on the transmission path.

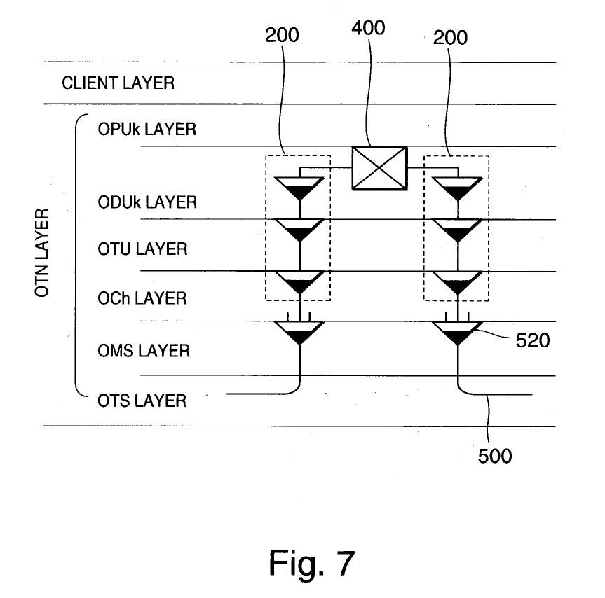

FIG. 7 illustrates processing by an OTN layer in the OTN XC apparatus, which is the first embodiment of the invention. Signals from the inter-nodal optical fiber 500 terminated by the sublayers of optical multiplex section (OMS), optical channel with full functionality (OCh) and OTU are terminated by the ODUk sublayer and cross-connected. The termination by OCh, OUT and ODUk is processed by OTN framers 220 (the OTN framers 221 and 222 of FIG. 6) of interface cards 200 (the OTN interface card 201 and 202) FIG. 6. Cross-connection is accomplished by the switching unit 400.

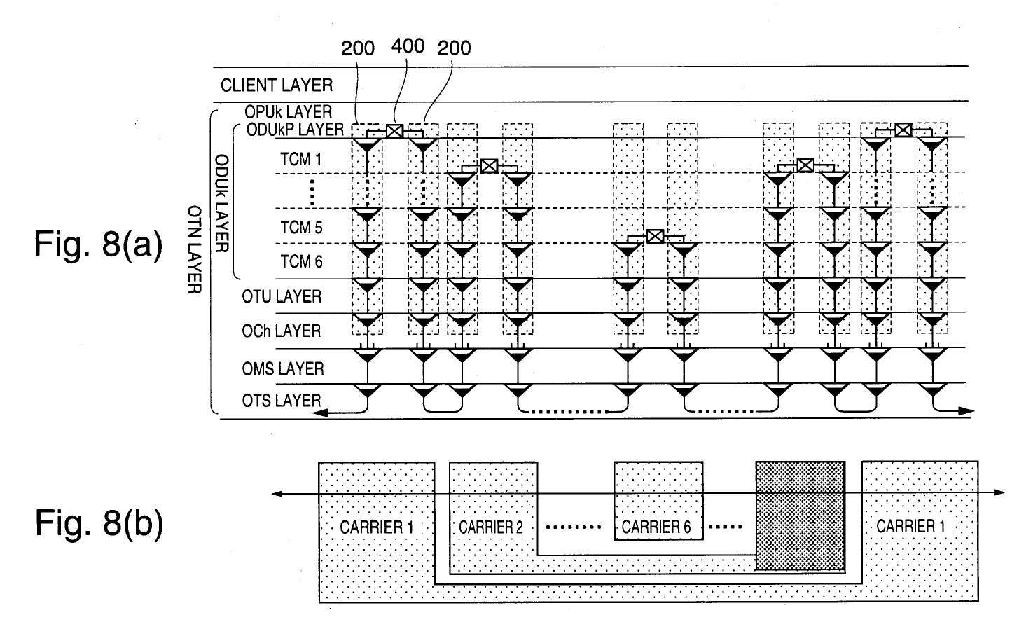

FIG. 8 illustrates layer processing using TCM by the first embodiment. FIG. 8(a) shows a layer model of the OTN network in tandem connection, and FIG. 8(b), the relationship of correspondence between the tandem connection and an n-th carrier or an n-th network (n=1, 2, . . . , 6).

Referring to FIG. 8, independent network management control is accomplished though using the same OTN frame by counting up by 1 a counter (not shown) indicating the TCM depth, i.e. the step (one or another of the six steps) of the ODUk sublayer, every time a signal passes a different network. Thus the count of the counter corresponds to another of carriers 1 through 6.

In the OTN-XC apparatus 100, if the count of the counter indicating the TCM depth is 1, the signals are terminated at TCM1 (the first step) of the ODUk sublayer, and cross-connected at an ODUk path monitoring sublayer (ODUkP sublayer). If the count is n (n is an integer of 2≦n≦6), they are terminated at TCMn (the n-th step). Details of the process follow the provisions of G.709 of ITU-T.

In more specific terms, termination processing of any ODUk tandem connection monitoring sublayer (ODUkT sublayer) is accomplished by the OTN framer 220 in an interface card 200.

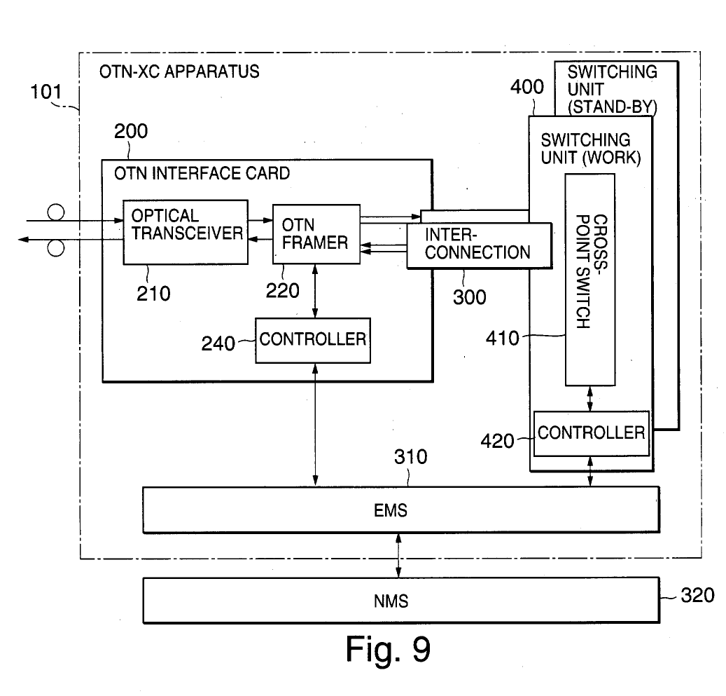

FIG. 9 through FIG. 12 illustrate apparatus control in the first embodiment. The OTN frame is terminated by the OTN framer 220 at the ODUk layer to read and write overhead (OH) information of the ODUk layer.

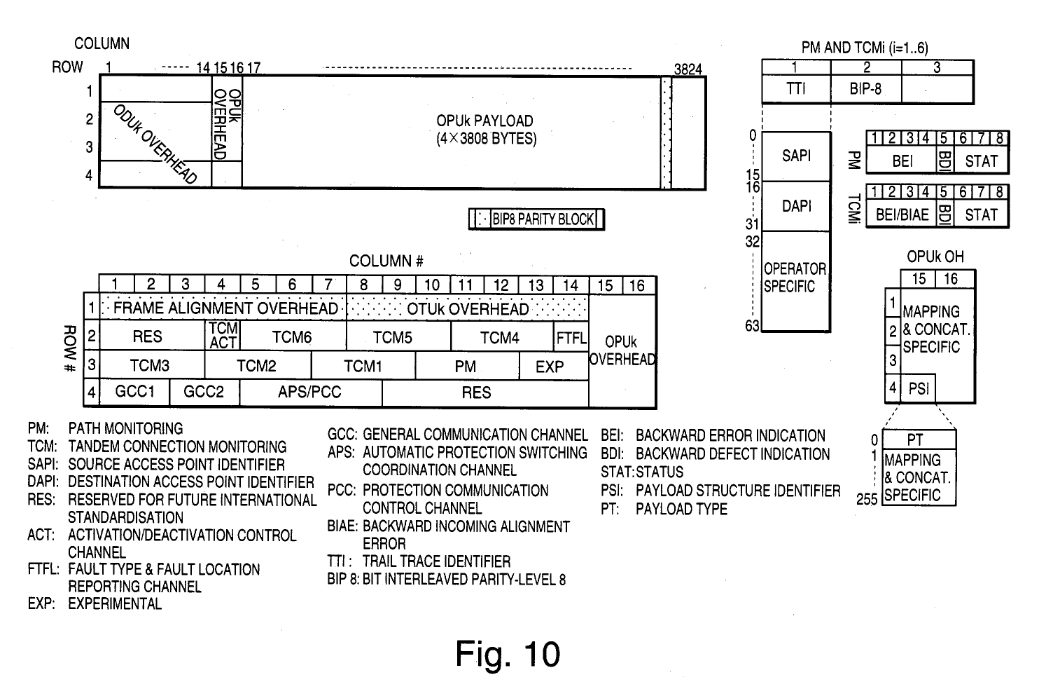

The OH information of OTN is defined under G.709 of ITU-T as shown in FIG. 10. The OH information is exchanged via a controller 240 controlling each component on each interface card 200 and an element management system (EMS) 310 controlling the whole apparatus within an OTN-XC apparatus 101 with a network management system (NMS) 320 which is present in the network and exercises control and management over the whole network.

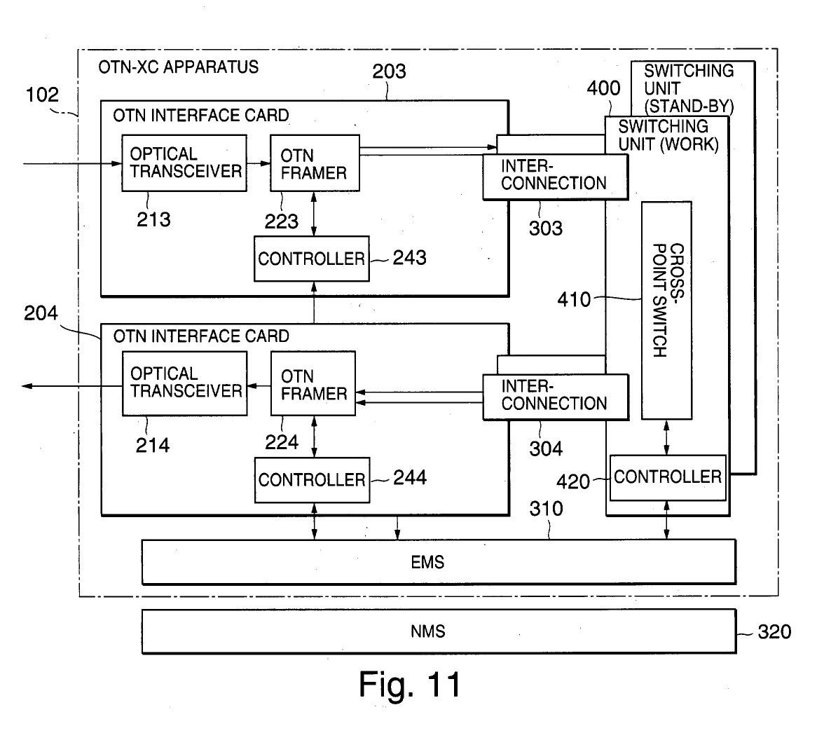

Details of OH processing that accompanies cross-connection will now be described with reference to FIG. 11. FIG. 11 shows a configuration in which an OTN interface card (A) 203 and an OTN interface card (B) 204 are connected via the switching unit 400 and signals of the OTN frame are passed within an OTN-XC apparatus 102.

Out of signals having arrived from the transmission path at the OTN interface card (A) 203, the OH information of OTN is read out by an OTN framer 223. At nodes which the OTN trail passes, the OH information of OTN to be processed comprises the OH information of ODUk and the OH information of OTUk, of which the OH information of OTUk is not explained here because it is an item of information that is concerned with management of the OTUk but has no direct part in the cross-connecting function. Description of the processing of forward error correction (FEC) will also be dispensed with for a similar reason to the above.

The OH information of ODUk read out by the OTN framer 223 is handed over to an EMS 310 of the OTN-XC apparatus 101 via a controller 243 of the OTN interface card (A) 203.

The EMS 310, after having processed the OH information of ODUk, supplies the OH information of ODUk and OTUk to an OTN framer 224 on the output side of the OTN frame signals via a controller 244 of the OTN interface card (B) 204. The OTN framer 224 of the OTN interface card (B) 204 writes the received OH information of ODUk and OTUk into the OH area of OTN signals to be sent out to the transmission path.

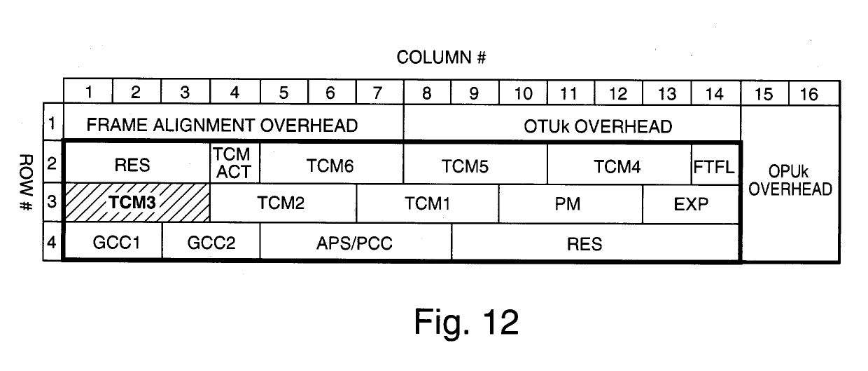

Processing of the OH information of ODUk will now be described in detail. Out of the OH information of ODUk read out of the OTN interface card (A) 203, TCM information corresponding to the TCM number to which the own apparatus belongs is terminated. For instance, where the TCM number managed by the network to which the own apparatus belongs is TCM3 (see FIG. 12), TCM3 in the OH information of ODUk is extracted by the OTN interface card (A) 203, and processing of the items of information defined as OH information is performed, such as the collation of the trail trace identifier (TTI) and the confirmation of the bit interleaved parity-8 (BIP-8).

Next, TTI information set from the NMS 320 and the EMS 310, BIP-8, backward defect indication (BDI) information and backward error indication (BEI) information undergo required processing by the OTN framer 224 of the OTN interface card (B) 204, written into TCM3 of the OH information of ODUk of signals to be sent out, and sent out to the transmission path. Then, TCM1, TCM2 and TCM4 through TCM6 are not rewritten but delivered to and sent out by the OTN interface card (B) 204, unchanged from the information received by the OTN interface card (A) 203.

More specifically, since transferring all of TCM1 through TCM6 of the OH information of ODUk from the OTN interface card (A) 203 to the OTN interface card (B) 204 via the EMS 310 would result in an unnecessary increase in the quantity of information transferred within the apparatus, the reality is that the received OH information is let pass the switching unit 400 as it is, and only the pertinent OH area is overwritten by the OTN interface card (B) 204.

The TCM number of the network to which the own apparatus belongs may be designated by the NMS 320 to each OTN-XC apparatus in the network to be held by the EMS 310, or there can be a system to generate it by extending, for instance, generalized multi-protocol label switching (GMPLS) or any similar protocol, on any desired control channel. Incidentally, mapping of the SDH frame on the OTN frame is known to those skilled in the art, and therefore its description is dispensed with.

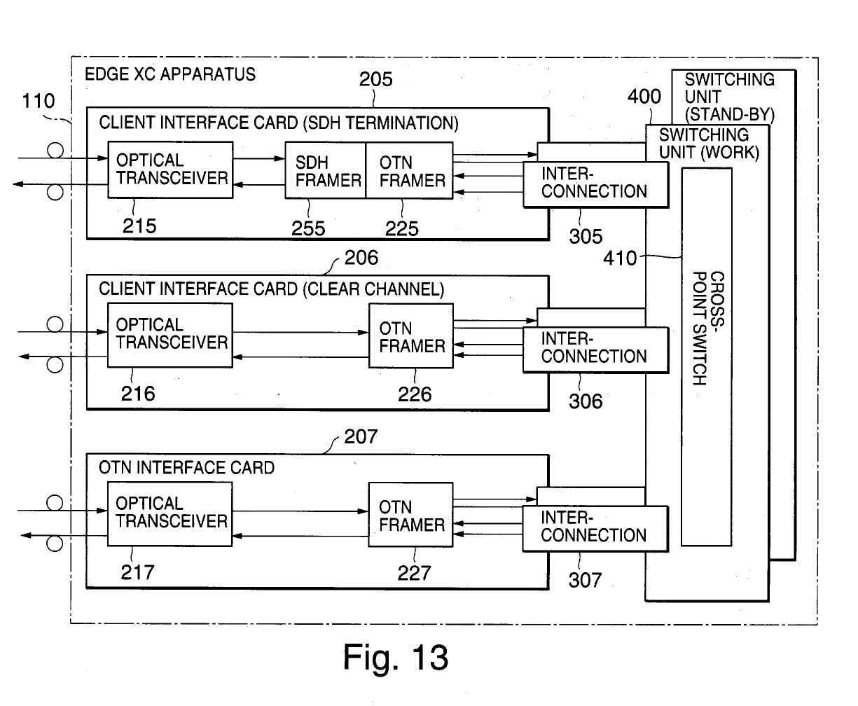

FIG. 13 is a block diagram of the configuration of an OTN XC apparatus, which is a second preferred embodiment of the invention. FIG. 13 shows the configuration of an edge XC apparatus 110 of OTN which constitutes a contact between the client network 1 and the OTN network 2.

The edge XC apparatus 110, like the first embodiment described above, is provided with a client interface card [client I/F card (SDH termination)] 205 and a client interface card (clear channel) 206 in addition to an OTN interface card 207 and the switching unit 400.

The client interface card 205 is provided with an optical transceiver 215, an SDH framer 255, an OTN framer 225 and an inter-connection 305; the client interface card 206 is provided with an optical transceiver 216, an OTN framer 226 and an inter-connection 306; and the OTN interface card 207 is provided with an optical transceiver 217; an OTN framer 227 and an inter-connection 307.

The bit rate of signals matching one of the logical connections on the OTN network 2 side is OTU-n (n=1, 2, 3) as prescribed by G.709 of ITU-T. That of signals matching one of the logical connections on the client network 1 side is either STM-N (N=16, 64, 256) or an equivalent thereto.

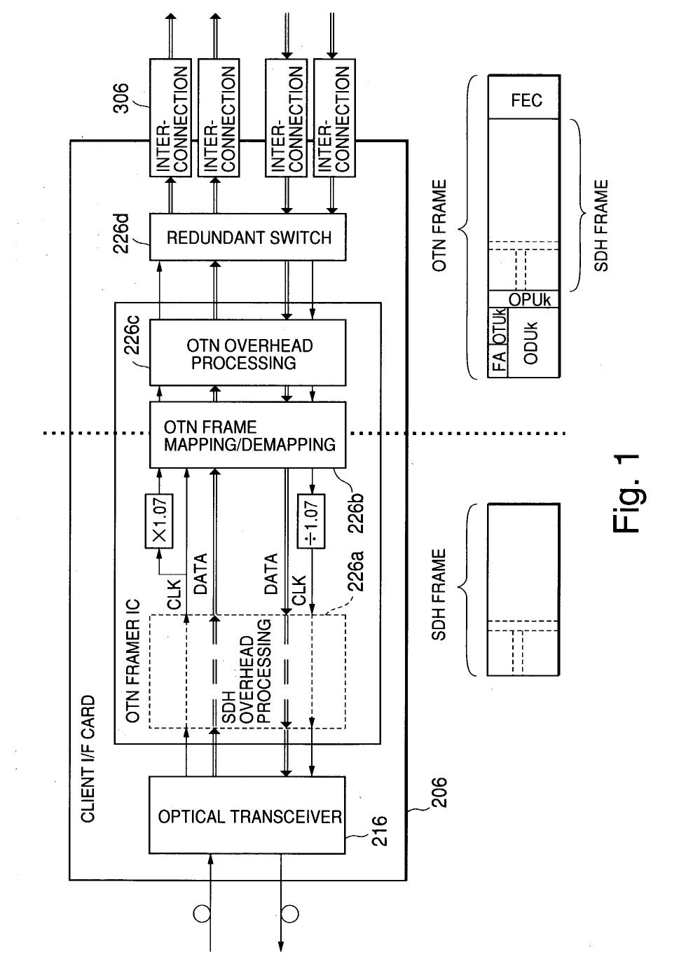

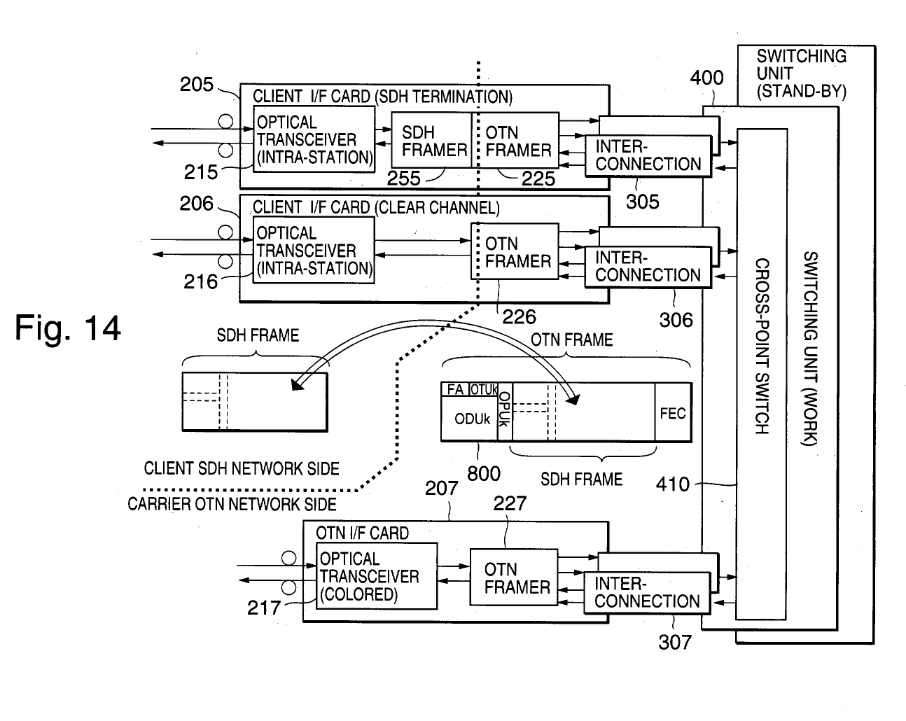

FIG. 14 and FIG. 1 illustrate the operation of the edge XC apparatus shown in FIG. 13. The operation of the edge XC apparatus 110 will be described below with reference to FIG. 13 and FIG. 1. The edge XC apparatus 110 has a function to adapt an SDH layer to the OTN layer so as to take signals of the client network into the OTN network 2. More specifically, it has a function to asynchronously map SDH and other client signals into the OTN frame. This client-OTN adapting function is contained in the client interface card 205 (see FIG. 14).

The interface card 207 on the OTN network 2 side has the same configuration as what was described above with reference to the first preferred embodiment of the invention. The client interface card 205 comprises the optical transceiver [optical (SR) transceiver] 215 for connection to the equipment of the client network, a client frame processing circuit (SDHTRM) (SDH framer) 255, an OTN frame processing circuit (OTNTRM) (OTN framer) 225 and an inter-connection 305 connected to the switching unit 400.

The optical transceiver 215 has to be responsive to various interfaces matching different items of client network equipment. These interfaces include optical interfaces, electrical interfaces and transmission media whose standards include, for example, STM-N (N=16, 64, 256), OC-N (N=48, 192, 768) and 10 G Ethernet (R) prescribed in IEEE 802.3ae.

The client frame processing circuit 255 performs necessary termination processing upon signals of the client network using the signal frame formats prescribed by the standard protocols mentioned above.

The OTN frame processing circuit 225, in accordance with the provisions of G.709 of ITU-T, stores client signals (SDH frame) into an OTN frame 800 and takes out client signals stored in the OTN frame for the client network side. Conversely, for the OTN network side, it terminates the ODUk sublayer of the OTN frame. To add, the OTN frame processing circuit 226 of the client interface card 206 performs similar processing to the above-described (see FIG. 14). Since the processing to store or take out the SDH frame into or from the OTN frame is known to those skilled in the art, its description is dispensed with here.

The inter-connection 305, using electrical signals or optical signals, connects the OTN interface card 207 and the client interface card 205 to the switching unit 400. To add, the inter-connection 306 of the client interface card 206 is similar to the inter-connection 305 described above.

Hereupon, the slave synchronization system of the signal clock used in client-OTN adaptation will be described. When a client signal is to be stored from the client into the OTN network, the frequency of the OTN frame is generated in the client interface cards 205 and 206 from a clock extracted from the client side signal with a multiply circuit using PLL. When STM-16 is to be stored into OTU-1, for instance, the frequency is multiplied by about 1.07 because this involves an increase from 2,488 Gbps to 2,666 bps (see FIG. 1).

When a client signal is to be taken out of the OTN to the client network, the frequency on the client network side is generated from a clock extracted from the signal of the OTN frame with a multiply circuit using PLL. If, for instance, an STM-16 frame is taken out of OTU-1, conversely to the process of storing, the clock is multiplied by about 0.93. Where the client network requires particularly strict clock accuracy typified by SDH, this is followed by pointer processing of the SDH frame to transfer the clock.

This processing of slave synchronization of clock is used because the clock of the OTN network does not require so strict accuracy as the SDH network does and the frequency tolerance is relatively generous, as referred to in the description of the switching configuration of the first preferred embodiment.

(Second Preferred Embodiment)

The switching unit 400 in the second preferred embodiment of the invention has a configuration similar to the switching unit 400 in the first embodiment described above. Referring here to FIG. 1, the OTN frame processing circuit 226 of the client interface card 206 is mounted with functions to perform SDH overhead processing 226a, OTN frame mapping/demapping 226b and OTN overhead processing 226c, and a redundant switch 226d is arranged between this circuit and the inter-connection 306.

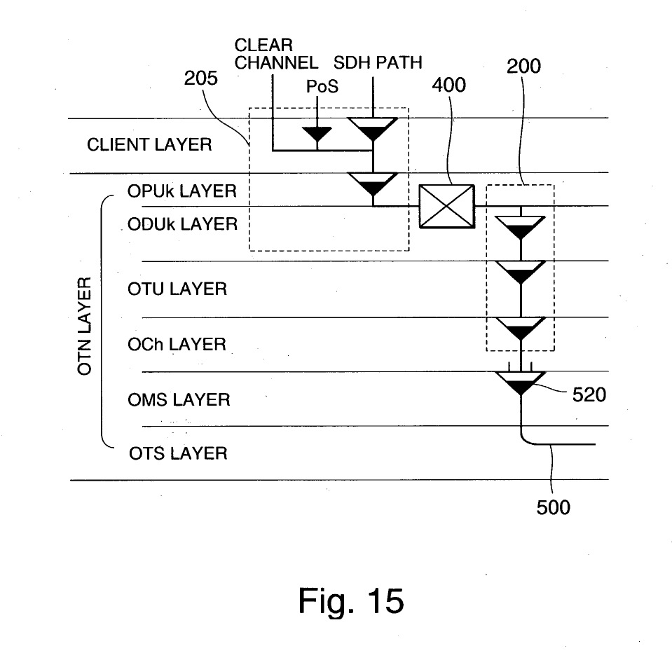

FIG. 15 illustrates processing by a client-OTN adaptation layer in the OTN XC apparatus, which is the second embodiment of the invention. Referring to FIG. 15, the client interface card 205 performs necessary termination processing, including SDH, for the client network upon signals from the client network side. After that, it stores the signals into the OTN frame at the termination of an optical channel payload unit-k (OPUk) sublayer, causes the switching unit 400 to perform cross-connection on the ODUk sublayer, and terminates OTU, OCh and OMS.

Conversely, for signals from the OTN to the client network, signals cross-connected on the ODUk sublayer are terminated to the OPUk sublayer to take out signals of the client network including SDH. Here is performed necessary termination processing for the client network to be transmitted to the client side network.

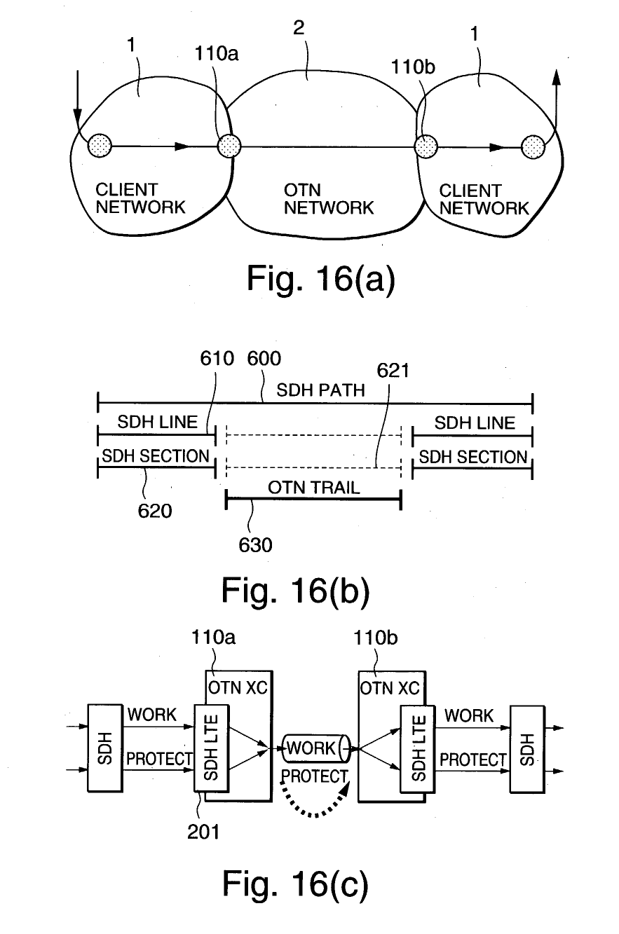

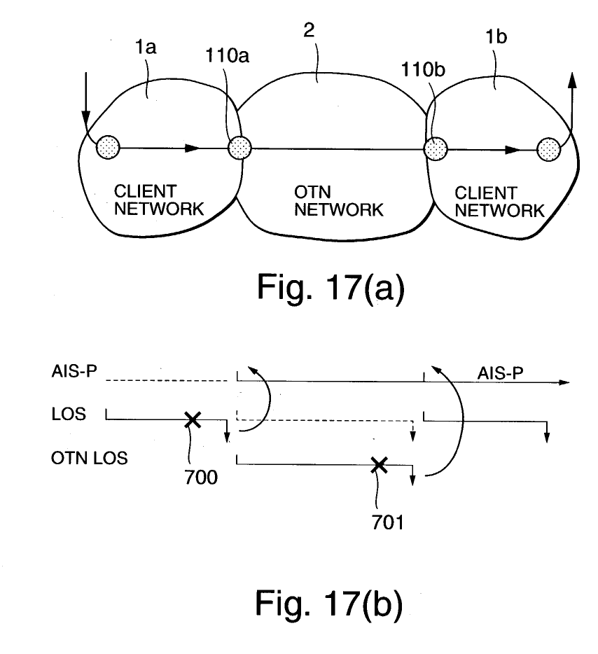

FIG. 16 through FIG. 19 illustrate processing by a network management system according to the invention. FIG. 16(a) shows a conceptual example of connection between networks differing in client section terminating system; FIG. 16(b), an example of the bus, line, section and trail of each network; FIG. 16(c), an example of matching hardware configuration and connection; FIG. 17(a), a conceptual example of connection between networks differing in client section terminating system; and FIG. 17(b), the flow of fault notifying information in the event of any fault.

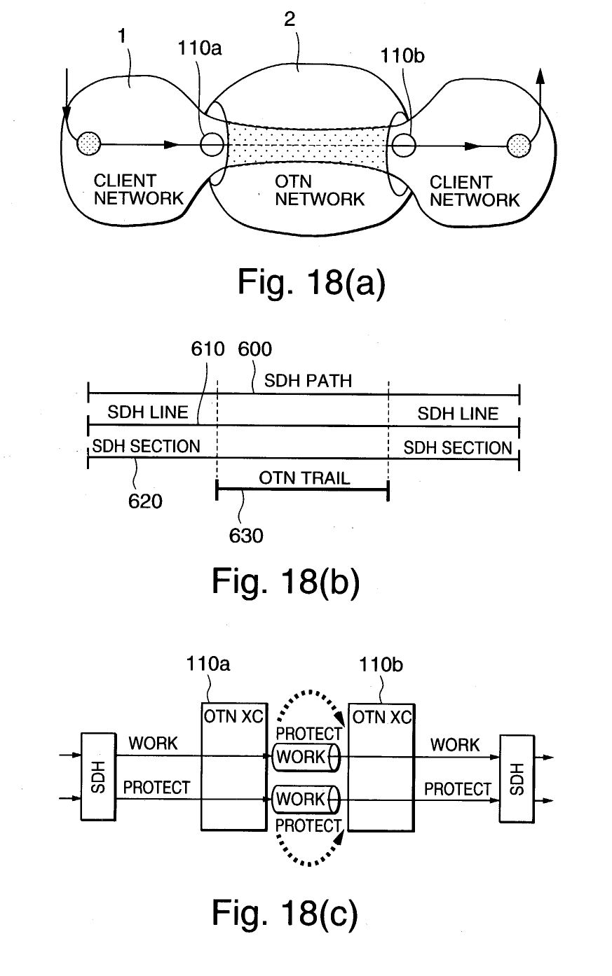

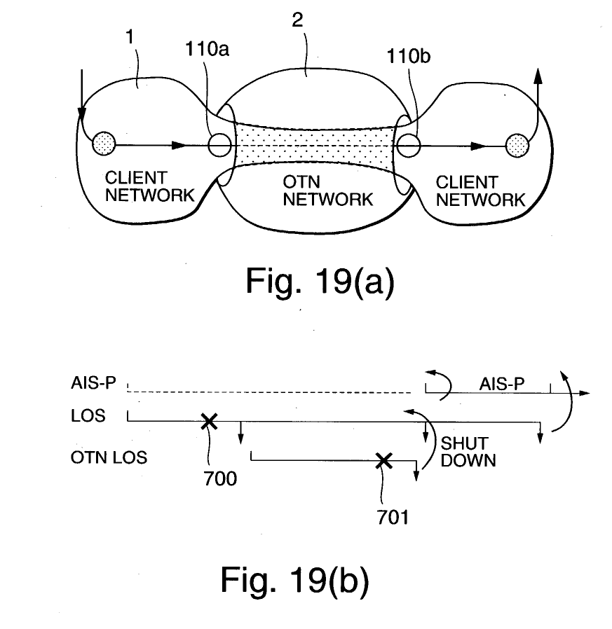

FIG. 18(a) shows a conceptual example of connection between networks differing in clear channel system; FIG. 18(b), an example of the bus, line, section and trail of each network; FIG. 18(c), an example of matching hardware configuration and connection; FIG. 19(a), a conceptual example of connection between networks differing in clear channel system; and FIG. 19(b), the flow of fault notifying information in the event of any fault. Terminating methods, especially for client signals in the OTN-XC apparatus according to the invention will be described with reference to these FIG. 16 through FIG. 19.

The client-OTN adapting function is realized by the client frame processing circuit and the OTN frame processing circuit. Two different adaptation systems are available, including the client section termination system shown in FIG. 16 and the clear channel system shown in FIG. 18. The difference between these two systems manifests itself, when the OH information of client signals is transmitted, according to whether or not the actuation of protection and control information are transferred between apparatuses at the time of network fault.

First will be described the client section termination. This is an extension of the traditional network configuration, positioned as something like a transitional measure. As an example of client section termination, a case in which the client network is an SDH network and SDH frame signals are subjected to section termination will be described with reference to FIG. 16.

The client side interface card 205 of the OTN edge node which adapts the SDH network and the OTN network terminates an SDH section 620 (and line 610) of the SDH network. Since no time division multiplexing of the SDH layer is performed in the scope of networks which the present invention presupposes, the line is degenerated into the section. Therefore, only the section will be discussed in the following description.

An SDH bus 600 continues into the OTN network. For this reason, immediately before adaptation to the OTN network, a new SDH section 621 is set. However, as this section 621 is terminated upon return from the OTN network 2 to the SDH network 1 and completely duplicates a trail 630 of the OTN network, it has no substantial sense.

An advantage of the termination system according to the invention consists in a reduction of the reserve band required over the full span of the bus 600, and a disadvantage lies in the discontinuity of control and management information. Since the section 610 is discontinuous before and after the OTN network 2 in the termination system according to the invention and accordingly the detection of any fault point is carried out in each individual network, operation following the conventional form of network management can be easily accomplished.

Furthermore, in the SDH network, if the conventional 1+1 protection system is used, it is possible to choose between a currently used bus and a reserve bus on the SDH network side at an OTN network edge cross-connect 110a, and the path of SDH signals within the OTN network can be treated as only one normal path. If the OTN network uses here a 1:N mesh protection system, less than 100% of the currently used band will be sufficient to meet the reserve band requirement in the OTN network. Therefore, the use of the termination system according to the invention makes it possible to reduce the band required over the full span of the bus, compared with a case in which the whole span is built up of the SDH network.

In the termination system according to the invention, because equipment of the OTN network performs termination of the SDH section, the management information or the protective function on the SDH network side cannot penetrate the inside of the OTN network, making it impossible to obtain a continuous SDH network. Network management information contained in the OH information of SDH including, for instance, the J0 byte, D1 through D3 bytes and K1 and K2 bytes is erased by equipment of the OTN network, resulting in inability to obtain continuity of control and management information.

FIG. 17 is a patterned diagram of the protecting operation. The protection can be classified into three cases according to the position of fault occurrence.

Thus, first, in the event of occurrence of a fault point 700 in the SDH network before the OTN network, an alarm indication signal (AIS) is communicated at the same time with the detection of failure such as a loss of signal (LOS) or a loss of frame (LOF) at the time of terminating the SDH section of the OTN edge node 110a, and protection is actuated on the upstream SDH network 1a side [hereinafter referred to as Case (a)].

Second, in the event of occurrence of a fault point 701 within the OTN network, protection within the OTN network is actuated by using an automatic protection switching/protection communication channel (APS/PCC) byte of the OTN frame [hereinafter referred to as Case (b)].

Third, in the event of occurrence of fault within the downstream side SDH network, it is treated by SDH protection enclosed within the downstream side SDH network [hereinafter referred to as Case (c)].

Of these three cases of fault, in Case (b), a fault will also occur in information to be communicated to the downstream SDH network 1b by the time the protection of the OTN network is completed, and fault detection will be carried individually in the downstream SDH network 1b as well. Then, protection is individually actuated in the OTN network 2 and the SDH network 1b, possibly inviting contention between the two processes of protection.

In this case, it is necessary to carry out complex and non-standard processing for avoiding contention, such as (1) providing a delay in the actuation of protection on the SDH side equivalently to the time taken by the OTN network for protection processing; (2) performing arbitration control via the network control system; and (3) forcibly entering AIS information into the OH of the SDH signal, which is the payload, in OTN OH processing at the outlet side cross-connect 110b from the OTN network to the SDH network.

Now will be explained the clear channel. A clear channel lets OH information on the SDH network side, which is the client, pass the OTN network while keeping it held. This clear channel, as described in SUMMARY OF THE INVENTION, is a service that is needed when unique signaling, whose transfer is not supported by a standard SDH apparatus, is to be accomplished in the client network using a non-standard SDHOH byte.

The clear channel service will now be explained with reference to FIG. 18. The clear channel service maps all the information on the payload portion of the OTN frame without terminating a section 620 of the SDH in the edge XC apparatus 110 for performing adaptation of the SDH network 1 and the OTN network 2, and never manipulates SDH OH information. Thus, as a matter of principle, any signal not in the form of the SDH frame, only if it has the bit rate of SDH signals, can be adapted as it is.

The bit rate is subordinate to the clock on the SDH network side. More specifically, in the case of STM-64/OTU-2, when adaptation takes place from SDH to OTN, the clock on the SDH side is multiplied in frequency by about 1.07, and the frequency-multiplied clock is communicated to the OTN network. Since individual signals do not require synchronism of the clock frequency in the OTN network, the frequency-multiplied clock as it is penetrates the OTN network. Since the OTN network and the equipment therein do not perform multiplexing/demultiplexing of OTN signals, frequency jitter of signals is irrelevant to them. At the time of adaptation to the SDH network on the outlet side of the OTN network, the frequency of the clock is again divided by about 0.93, and the payload portion of the OTN frame is transmitted as it is toward the SDH network. The frequency jitter of signals having returned to the SDH network is absorbed by some equipment on the SDH network side.

As shown in FIG. 18, in this clear channel form, the section 620 of the SDH network penetrates the OTN network and continues to and after the outlet. Management of the OTN network is closed within the OTN network alone and, as viewed from the SDH network, the OTN network becomes transparent, resulting in the advantage that the control system of the SDH network 1 need not be conscious of the OTN network 2. This advantage means that, when signals are to be transmitted via a plurality of different carrier networks, any fault pertaining to the communication of control information between carriers can be averted.

As routes in current use and for reserve are independent between the two ends of the SDH bus, no contention between the two processes of protection arises, and the N:1 protection on the OTN network side, independent of the SDH network, individually protects the two SDH buses, making it possible to enhance the reliability of communication.

FIG. 19 is a patterned diagram of the protecting operation in another way. Faults can be classified into two kinds: some occurring in the OTN network and others, in the SDH network. In the first category, if the fault point 700 occurs on the SDH network side, the fault is detected by a terminal node of the SDH network and SDH protection closed within the SDH network takes place. In the second category, if the fault point 701 arises within the OTN network, protection of the OTN network is actuated using the APS/PCC byte of the OTN frame. If the speed of protection is slow, the fault is detected on the SDH network side and SDH protection is actuated.

In the first case, as the OTN network is transparent as viewed from the SDH network, and the SDH section penetrates the OTN network and continues, the conventional 1+1 SDH protection operates spanning the SDH networks on two sides with the OTN network between them. In this process, protection on the OTN side is never actuated.

In the second case, a fault is first detected on the OTN network side, and protection is actuated within the OTN network. If this protection is fast enough, the SDH side detects no fault, and the protection processing is completed. Where the OTN network uses a relatively slow N:1 mesh restoration, a fault is detected on the SDH network side before the OTN network is restored from its fault, and 1+1 SDH protection processing is actuated. In this case, the reserve route on the SDH side passes the OTN network via a different route from the one on which the fault has arisen. After that, the faulty route in the OTN network is restored in a slow process.

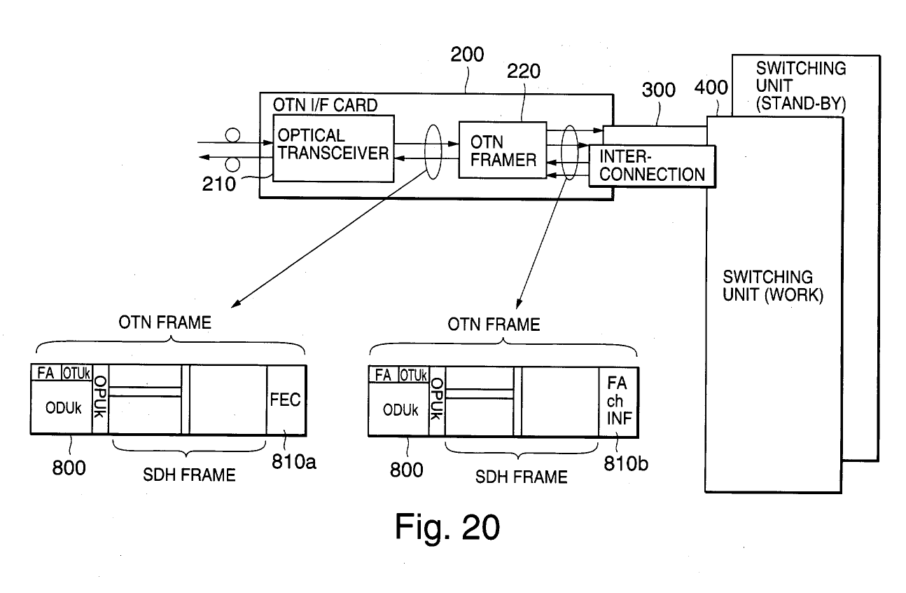

FIG. 20 is a block diagram of the configuration of an OTN XC apparatus, which is another embodiment of the invention. Referring to FIG. 20, a signal having arrived at the interface card 200 of the OTN-XC apparatus from the transmission path is terminated by the OTN framer 220, and in the range of an interface 300 and the switching unit 400 within the OTN-XC apparatus, an FEC code area 810a of the OTN frame 800 is unused. As this unoccupied FEC code area can be deemed to be a freely usable area closed within the apparatus, it can be provided for use in intra-apparatus signaling.

By entering simple BIP-8 and BIP-32 codes for confirming an information transfer at the time of a continuity test between the interface card 200 and the switching unit 400 or any error within the apparatus, for instance, and having them as unique specifications of the apparatus, high reliability of the OTN-XC apparatus can be achieved.

Or where signals derived from OTU-2 or OTU-3 are to be processed by the OTN-XC apparatus and the operating bands of electrical circuits within the apparatus are below the respective bit rates of the signals, they may be required to be processed as, for instance, four-channel or 16-channel low speed parallel signals. At the time of recombining these developed parallel signals, it is necessary to identify the channel sequence of the low speed signals and to adjust the byte phase.

A system generally used in conventional SDH apparatuses detects the boundary between A1 and A2 bytes invariably existing at the leading edge of the SDH frame or replaces part of a plurality of consecutive A1 and A2 bytes with parallel channel information. However, since the OTN frame 800 has a total of only six frame alignment (FA) OH bytes, which correspond to SDH A1 and A2 bytes, parallel development of bytes over four channels will result in the presence of some channels having no frame alignment OH, making impossible either channel identification or phase adjustment.

In order to avert this phenomenon, 16 or more dummy frame alignment OH bytes and parallel channel information 810b are entered into the FEC code area. By using this system, it is made possible to realize adjustment at the time of recombination from parallel into serial data in the same way as in conventional SDH apparatuses.

Thus according to the present invention, a network independent of and non-interfering with the frame of client signals can be built up by using a cross-connecting apparatus which maps the client signals in the payload portion of the OTN frame prescribed by G.709 of ITU-T and cross-connects the mapped signals on the ODUk sublayer of the OTN layer.

Therefore, by using the OTN XC apparatus according to the invention, it is made possible to provide client signals, such as SDH/SONET/10 GbE or the like, with a clear channel service via networks differing in management system such as between a plurality of carriers.

As hitherto described, according to the invention, in a cross-connecting apparatus having a circuit containing in it a plurality of connecting routes, the clocks of a plurality of signals arriving from an external transmission path, differing from one another in phase, need not be replaced with local clocks and can be cross-connected by slave-synchronizing each circuit to the clock rate of input signals, and the output signals are generated from the result of that cross-connection. This results in the advantage that a clear channel service can be provided via networks differing in management system such as between a plurality of carriers.

While this invention has been described with reference to certain preferred embodiments thereof, it is to be understood that the subject matter encompassed by this invention is not to be limited to those specific embodiments. Instead, it is intended for the subject matter of the invention to encompass all such alternative modifications and equivalents as can be included within the spirit and scope of the following claims.

What is claimed is:

1. A network in which some of the lines of a client network for transmitting client signals comprise a carrier network for transmitting an optical transport network (OTN) frame, including in the carrier network:
a switching apparatus including a mapping unit for mapping said client signals on the payload portion of said OTN frame and a switching unit for switching the frame on which said client signals are mapped by said mapping unit on the optical channel data unit-k (ODUk) sublayer of an OTN layer.

2. The network, as claimed in claim 1, wherein said client signals constitute a synchronous optical network/synchronous digital hierarchy (SDH/SONET)-based frame.

3. The network, as claimed in claim 1, wherein said switching unit performs switching of a signal independent of a clock rate and with an OTN bit rate having a tolerance width for the operating range of said clock rate.

4. The network, as claimed in claim 3, wherein said switching unit comprises one of an analog switching circuit, a digital cross-point switching circuit using phase locked loop (PLL) permitting slave synchronization, and an optical switch entailing no photoelectric conversion.

5. The network, as claimed in claim 1, wherein said network performs independent network management control according to the count of a counter which is counted up every time said carrier network or the network is passed.

6. The network, as claimed in claim 1, wherein said switching apparatus uses said OTN frame for the frame format of a plurality of input/output signals, and controls and manages itself by using a tandem connection monitoring area of optical transport network (OTN) overhead information.

7. The network, as claimed in claim 6, wherein said client signal stored in the payload portion of said OTN frame is allowed to penetrate without having to rewrite overhead information and without interference.

8. The network, as claimed in claim 6, wherein said client signal is allowed to be either stored into said OTN frame or taken out of said OTN frame without having to rewrite said overhead information and without interference.

9. The network, as claimed in claim 6, wherein said switching apparatus comprises the overhead processing circuit of said client signal in the interface card on said client signal side; said overhead processing circuit has a function to terminate the overhead information of said client signal and a network protecting function for the client network; and either stores into said OTN frame or takes out of said OTN frame.

10. The network, as claimed in claim 8, wherein one in each pair of a plurality of pairs of input/output signals uses the frame format of said OTN frame and the other uses the frame format of said client signal, and an adapting function is provided to link different networks using the two different frame formats.

11. The network, as claimed in claim 3, wherein said network further comprises a circuit for either writing into or reading out of the forward error correction (FEC) area of said OTN frame, and wherein a management control signal for the inside of an apparatus terminated between interface cards on two sides, having between them said switching means, is generated, and is transferred either between said interface cards or between said interface card and said switching means.

12. The network, as claimed in claim 11, wherein information in the tandem connection monitoring area of the pertinent overhead information is let pass between said interface cards by exchanging the overhead information of said OTN frame between controllers for controlling each component on said interface cards and a network management system (NMS) for controlling and managing the whole network via an element management system (EMS) for controlling the whole of said switching apparatus.

13. The network, as claimed in claim 11, wherein information in the tandem connection monitoring area of the pertinent overhead information is let pass between said interface cards by exchanging the overhead information of said OTN frame between said interface cards via said switching means.

14. The network, as claimed in claim 12, wherein information of said tandem connection monitoring area set by either an element management system (EMS) for controlling the whole of said switching apparatus and a network management system (NMS) for controlling and managing the whole network is written into the pertinent portion of the tandem connection monitoring area of said overhead information having passed between said interface cards.

15. A switching apparatus including a mapping unit for mapping said client signal on the payload portion of an optical transport network (OTN) frame and a switching unit for switching the frame on which the client signals are mapped by said mapping unit on the optical channel data unit-k (ODUk) sublayer of an OTN layer.

16. The switching apparatus, as claimed in claim 15, wherein said client signals constitute an SDH/SONET-based frame.

17. The switching apparatus, as claimed in claim 15, wherein said switching unit performs switching of a signal independent of a clock rate and with an OTN bit rate having a tolerance width for the operating range of said clock rate.

18. The switching apparatus, as claimed in claim 17, wherein said switching unit comprises one of an analog switching circuit, a digital cross-point switching circuit using phase locked loop (PLL) permitting slave synchronization, and an optical switch entailing no photoelectric conversion.

19. The switching apparatus, as claimed in claim 15, wherein said switching apparatus performs independent network management control according to the count of a counter which is counted up every time said carrier network or the network is passed.

20. The switching apparatus, as claimed in claim 15, which uses said OTN frame as the frame format of a plurality of pairs of input/output signals and the tandem connection monitoring area of OTN overhead information is used for controlling and managing itself.

21. The switching apparatus, as claimed in claim 20, wherein said client signal stored in the payload portion of said OTN frame is allowed to penetrate without having to rewrite overhead information and without interference.

22. The switching apparatus, as claimed in claim 20, wherein said client signal is allowed to be either stored into said OTN frame or taken out of said OTN frame without having to rewrite said overhead information and without interference.

23. The switching apparatus, as claimed in claim 20, wherein the interface card on said client signal side includes the overhead processing circuit of said client signal;
said overhead processing circuit has a function to terminate the overhead information of said client signal and a network protecting function for the client network; and either stores into said OTN frame or takes out of said OTN frame.

24. The switching apparatus, as claimed in claim 22, wherein one in each pair of a plurality of pairs of input/output signals uses the frame format of said OTN frame and the other uses the frame format of said client signal, and an adapting function is provided to link different networks using the two different frame formats.

25. The switching apparatus, as claimed in claim 17, wherein said switching apparatus further comprises a circuit for either writing into or reading out of the FEC area of said OTN frame, and wherein a management control signal for the inside of an apparatus terminated between interface cards on two sides, having between them said switching means, is generated, and is transferred either between said interface cards or between said interface card and said switching means.

26. The switching apparatus, as claimed in claim 25, wherein information in the tandem connection monitoring area of the pertinent overhead information is let pass between said interface cards by exchanging the overhead information of said OTN frame between controllers for controlling each component on said interface cards and a network management system (NMS) for controlling and managing the whole network via an element management system (EMS) for controlling the whole of said switching apparatus.

27. The switching apparatus, as claimed in claim 25, wherein information in the tandem connection monitoring area of the pertinent overhead information is let pass between said interface cards by exchanging the overhead information of said OTN frame between said interface cards via said switching unit.

28. The switching apparatus, as claimed in claim 26, wherein information of said tandem connection monitoring area set by either an element management system (EMS) for controlling the whole of itself and a network management system (NMS) for controlling and managing the whole network is written into the pertinent portion of the tandem connection monitoring area of said overhead information having passed between said interface cards.

29. An OTN frame processing method for use in a network in which some of the lines of a client network for transmitting client signals comprise a carrier network for transmitting an OTN frame, whereby said client signals are mapped on the payload portion of said OTN frame and the frame on which said client signals are mapped is switched on the ODUk sublayer of an OTN layer.

30. The OTN frame processing method, as claimed in claim 29, wherein said client signals constitute an SDH/SONET-based frame.

31. The OTN frame processing method, as claimed in claim 29, whereby switching on said ODUk sublayer is performed on a signal independent of a clock rate and with an OTN bit rate having a tolerance width for the operating range of said clock rate.

32. The OTN frame processing method, as claimed in claim 31, whereby switching on said ODUk sublayer is performed by one of an analog switching circuit, a digital cross-point switching circuit using phase locked loop (PLL) permitting slave synchronization, and an optical switch entailing no photoelectric conversion.

33. The OTN frame processing method, as claimed in claim 29, whereby independent network management control is performed according to the count of a counter which is counted up every time said carrier network or the network is passed.

34. The OTN frame processing method, as claimed in claim 29, whereby said OTN frame is used as the frame format of a plurality of pairs of input/output signals and the tandem connection monitoring area of OTN overhead information is used for controlling and managing the own apparatus.

35. The OTN frame processing method, as claimed in claim 34, whereby said client signal stored in the payload portion of said OTN frame is allowed to penetrate without having to rewrite overhead information and without interference.

36. The OTN frame processing method, as claimed in claim 34, whereby said client signal is allowed to be either stored into said OTN frame or taken out of said OTN frame without having to rewrite said overhead information and without interference.

37. The OTN frame processing method, as claimed in claim 34, whereby the overhead processing circuit of said client signal contained in the interface card on said client signal side has a function to terminate the overhead information of said client signal and a network protecting function for the client network; and either storing into said OTN frame or taking out of said OTN frame is performed.

38. The OTN frame processing method, as claimed in claim 36, whereby one in each pair of a plurality of pairs of input/output signals uses the frame format of said OTN frame and the other uses the frame format of said client signal, and an adapting function is provided to link different networks using the two different frame formats.

39. An OTN frame processing circuit for processing an OTN frame in a switching apparatus, wherein byte information in either a random position or a specific position is at least either read or written out of or into an unused FEC area of the OTN frame.

40. An integrated circuit constituting an OTN frame processing circuit which processes an OTN frame in a switching apparatus, wherein byte information in either a random position or a specific position is at least either read or written out of or into an unused FEC area of the OTN frame.
